(19) United States
(12) Patent Application Publication
(10) Pub. No.: US 2014/0139225 A1
(43) Pub. Date: May 22, 2014

(54) WELL MONITORING WITH OPTICAL ELECTROMAGNETIC SENSORS

(71) Applicant: HALLIBURTON ENERGY SERVICES, INC., Houston, TX (US)

(72) Inventor: Tasneem A. MANDVIWALA, Katy, TX (US)

(73) Assignee: HALLIBURTON ENERGY SERVICES, INC., Houston, TX (US)

(21) Appl. No.: 13/679,926

(22) Filed: Nov. 16, 2012

(51) Int. Cl. G01V 3/26

(52) U.S. Cl. CPC G01V 3/26
USPC 324/344

(57) ABSTRACT

A method of measuring an electromagnetic field in a subterranean earth formation can include installing at least one electromagnetic sensor in a well, the sensor including an optical waveguide and a material, the material changing shape in response to exposure to the electromagnetic field, and strain in the optical waveguide changing in response to the material changing shape. A well system can include an optical electromagnetic sensor installed in a well, and a transmitter which induces an electromagnetic field in an earth formation. Strain is induced in an optical waveguide of the sensor in response to the electromagnetic field. A method of monitoring an earth formation can include installing an optical electromagnetic sensor in a wellbore which penetrates the formation, and a strain being induced in an optical waveguide of the sensor in response to the electromagnetic field.

### CROSS-REFERENCE TO RELATED APPLICATION

This application is related to application Ser. No. 13/648,897, filed on 10 Oct. 2012.

### BACKGROUND

This disclosure relates generally to equipment utilized and operations performed in conjunction with a subterranean well and, in an example described below, more particularly provides for well monitoring with optical electromagnetic sensors.

It can be useful to monitor a subterranean reservoir over time, in order to detect changes in the reservoir. For example, in conventional and enhanced oil recovery, processes such as water flooding, steam flooding and chemical flooding can be implemented. It is useful to monitor injection of water, steam or chemicals into a formation, and/or to monitor progress of the water, steam or chemicals toward or away from one or more wellbores. Monitoring a flood front helps avoid flood breakthroughs, and can save costs.

Therefore, it will be appreciated that improvements are continually needed in the art of monitoring changes in subterranean reservoirs. Such improvements may be used for monitoring flood front progress, or for monitoring other changes in an earth formation.

### BRIEF DESCRIPTION OF THE DRAWINGS

FIG. 1 is a representative partially cross-sectional view of a well system and associated method which can embody principles of this disclosure.

FIGS. 2-7 are representative views of optical electromagnetic sensors which may be used in the system and method of FIG. 1.

### DETAILED DESCRIPTION

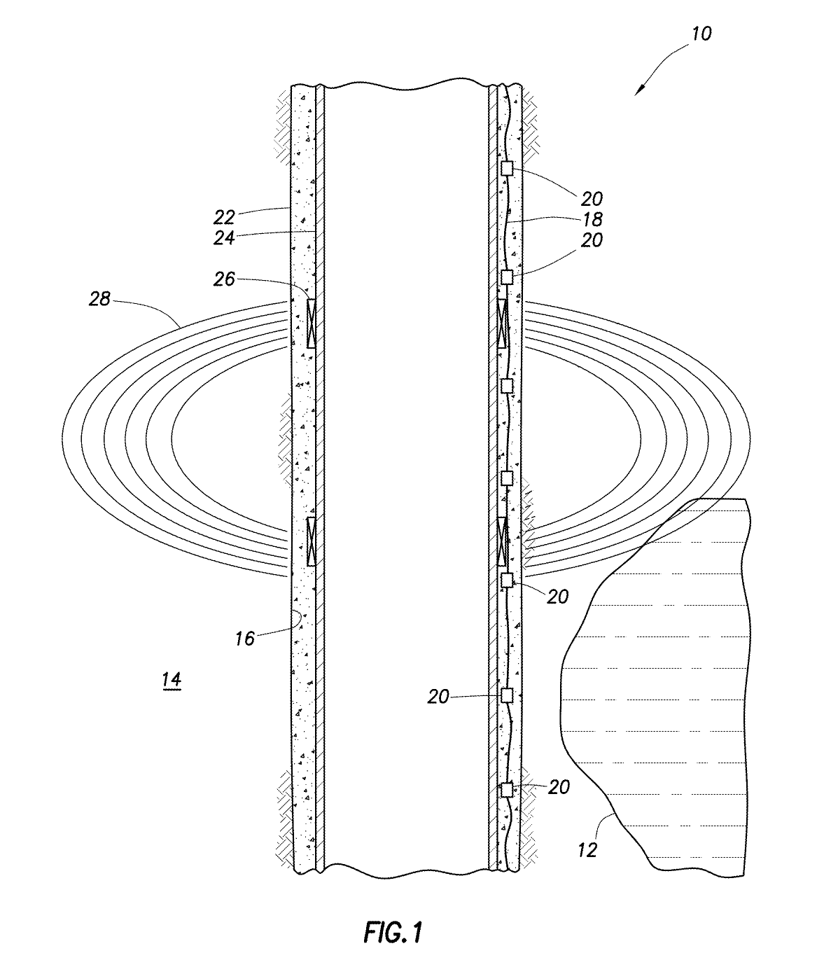

Representatively illustrated in FIG. 1 is a system 10 for use with a subterranean well, and an associated method, which system and method can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, the system 10 is used to monitor a flood front 12 as it progresses through an earth formation 14. For this purpose, optical electromagnetic sensors 20 are installed in a wellbore 16 along an optical cable 18. The cable 18 and sensors 20 are positioned in cement 22 surrounding casing 24.

The flood front's 12 progress may be monitored toward or away from the wellbore 16, or another characteristic of the formation 14 could be monitored, etc. Thus, the scope of this disclosure is not limited to the details of the example depicted in FIG. 1.

In the FIG. 1 system 10, monitoring of the flood front 12 is accomplished by detecting changes in the formation 14 over time. This is preferably accomplished by measuring resistivity contrasts. The resistivity of the formation 14 is obtained through the measurement of electromagnetic fields in the formation using the optical electromagnetic sensors 20, which are preferably permanently installed in the wellbore 16, so that continuous monitoring over time is available.

A transmitter 26 can be used to generate electromagnetic energy consisting of electric and magnetic field components. Thus, electromagnetic fields 28 (e.g., primary, secondary, etc., fields) are induced in the formation 14. However, it should be clearly understood that the scope of this disclosure is not limited at all to any particular way of inducing electromagnetic fields in a formation, or to any particular type of electromagnetic fields induced in a formation.

The transmitter 26 could comprise coils external to the casing 24. In other examples, the casing 24 itself could be used to generate the electromagnetic fields 28, such as, by using the casing as a conductor.

In further examples, the transmitter 26 could be positioned in another wellbore, at the earth's surface, or in another location. The scope of this disclosure is not limited to any particular position of a transmitter, to any particular type of transmitter, or to any particular technique for generating an electromagnetic field in the formation 14.

The sensors 20 detect the electromagnetic field 28. Measurements of the electromagnetic field 28 are then inverted to obtain the resistivity of the formation 14.

In some examples, a time-lapse measurement may be performed, in which electric or magnetic fields at each sensor 20 location are measured as a function of time. In a time-lapse measurement system, first a sensor signal is recorded at a time when there is no flood. During reservoir monitoring for waterfront, a differential signal (between the no flood case and with flood case) at each sensor is recorded—which is the field due to flood. As the flood approaches closer to a sensor 20 (e.g., in a production well), the differential signal gets larger. The intensity of the signal indicates a distance to the flood front 12.

The final output of the system could either be resistivity or field due to flood, depending on a post-processing algorithm used. Direct field measurement is comparatively straightforward, while converting the direct measurement to resistivity makes the post-processing more complicated.

Basically, in the sensors 20, a physical perturbation interacts with an optical waveguide to directly modulate light traveling through the waveguide. This modulated signal travels back along the same or another waveguide to a signal interrogation system, where the signal is demodulated, and the corresponding perturbation is determined.

Preferably, an optical fiber (or another optical waveguide, such as an optical ribbon, etc.) is bonded to or jacketed by a ferromagnetic material which is a magnetostrictive material used as a magnetic field receiver. Such materials undergo a change in shape or dimension (e.g., elongation or contraction) in the presence of a magnetic field.

This property is known as magnetostriction. Some widely used magnetostrictive materials are Co, Fe, Ni, and iron-based alloys METGLAS™ and TERFENOL-D™.

The sensors 20 can be used to measure electric fields when the optical waveguide is bonded to or jacketed by a ferroelectric material which is an electrostrictive material. Ferroelectric materials undergo a change in shape or dimension in the presence of an electric field.

This property is known as electrostriction. Some examples of electrostrictive ceramics are lead magnesium niobate (PMN), lead magnesium niobate-lead titanate (PMN-PT) and lead lanthanum zirconate titanate (PLZT).

However, it should be clearly understood that the scope of this disclosure is not limited to use of any particular magnetostrictive or electrostrictive material. Any suitable material which changes shape in response to exposure to a magnetic and/or electric field may be used.

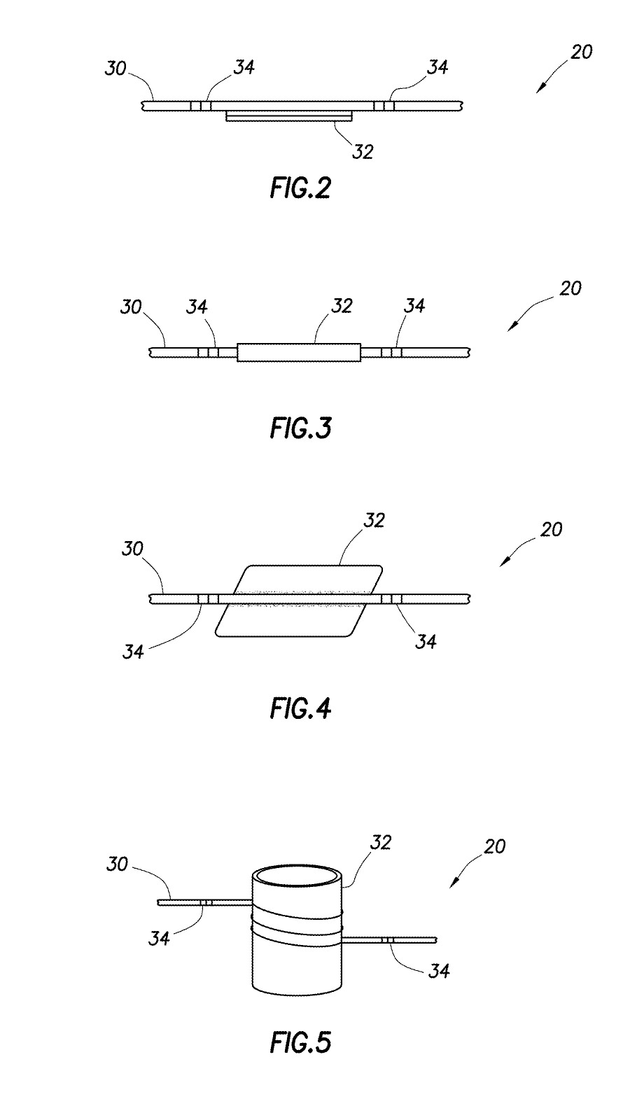

Referring additionally now to FIGS. 2-5, several examples of the sensor 20 are representatively illustrated. In each of these examples, an optical waveguide 30 is bonded or otherwise attached to a material 32 which changes shape in response to exposure to an electric and/or magnetic field.

The FIGS. 2-5 examples use fiber Bragg gratings 34 in the optical waveguide 30. These fiber Bragg gratings 34 may be useful, for example, with intrinsic Fabry-Perot interferometry techniques, but would not be used, for example, with Michelson or Mach Zehnder interferometry techniques.

In the FIG. 2 example, the material 32 is in the form of a wire or rod which is bonded to a section of the waveguide 30 longitudinally between two fiber Bragg gratings 34. For example, an epoxy may be used to adhere the optical waveguide 30 to the material 32.

When the material 32 changes shape, the length of the optical waveguide 30 bonded to or jacketed by the material is elongated or contracted between the Bragg gratings 34. Thus, strain is induced in the waveguide 30 between the Bragg gratings 34 due to the electromagnetic field 28.

In FIG. 3, the waveguide 30 is jacketed or coated (surrounded) by the material 32. The material 32 is bonded or otherwise adhered to an outer surface of the waveguide 30.

In FIG. 4, the material 32 is planar in form. Again, the material 32 is bonded to the waveguide 30 between the Bragg gratings 34.

In FIG. 5, the waveguide 30 is wrapped about the material 32, which is in cylindrical form. The waveguide 30 is not necessarily bonded to the material 32, since a radial enlargement or contraction of the cylindrical material will change strain in the waveguide 30 without such bonding. However, the waveguide 30 could be bonded to the material 32 in this example, if desired.

In the FIGS. 2-5 examples, a change in strain (or change in length per unit length) can be induced in the waveguide 30 due to a change in shape of the material 32. Note that the fiber Bragg gratings 34 are optional in the sensor 20 examples of FIGS. 2-5, but are preferably used in a Fabry-Perot interferometer scheme to enable multiplexing in some examples.

The strain (for magnetostrictive material 32) is given by:

ε₃=CH² (1)

where C is an effective magnetostrictive coefficient, and H is a sum of alternating and direct magnetic fields (H_{ac} and H_{dc}). Expanding the H field term, and extracting only the term that has the same frequency as the original H_{ac} gives:

ε₃=2CH_{ac}H_{dc} (2)

This indicates that the strain is linearly proportional to the magnetic field.

Similarly, the strain (for an electrostrictive material 32) is given by:

ε₃=ME² (3)

where M is an effective electrostrictive coefficient, and E is a sum of alternating and direct electric fields (E_{ac} and E_{dc}). Expanding the E field term, and extracting only the term that has the same frequency as the original E_{ac} gives:

ε₃=2ME_{ac}E_{dc} (4)

This indicates that the strain is linearly proportional to the electric field.

The strain (due to magnetostriction or electrostriction of the material 32) can be measured using interferometric methods, such as Mach-Zehnder, Michelson, Sagnac, Fabry-Perot, etc. The Bragg gratings 34 in the FIGS. 2-5 examples can be particularly useful in multiplexing, using the intrinsic Fabry-Perot type of interferometer, but the scope of this disclosure is not limited to use of the Bragg gratings, or to use of any particular type of interferometer.

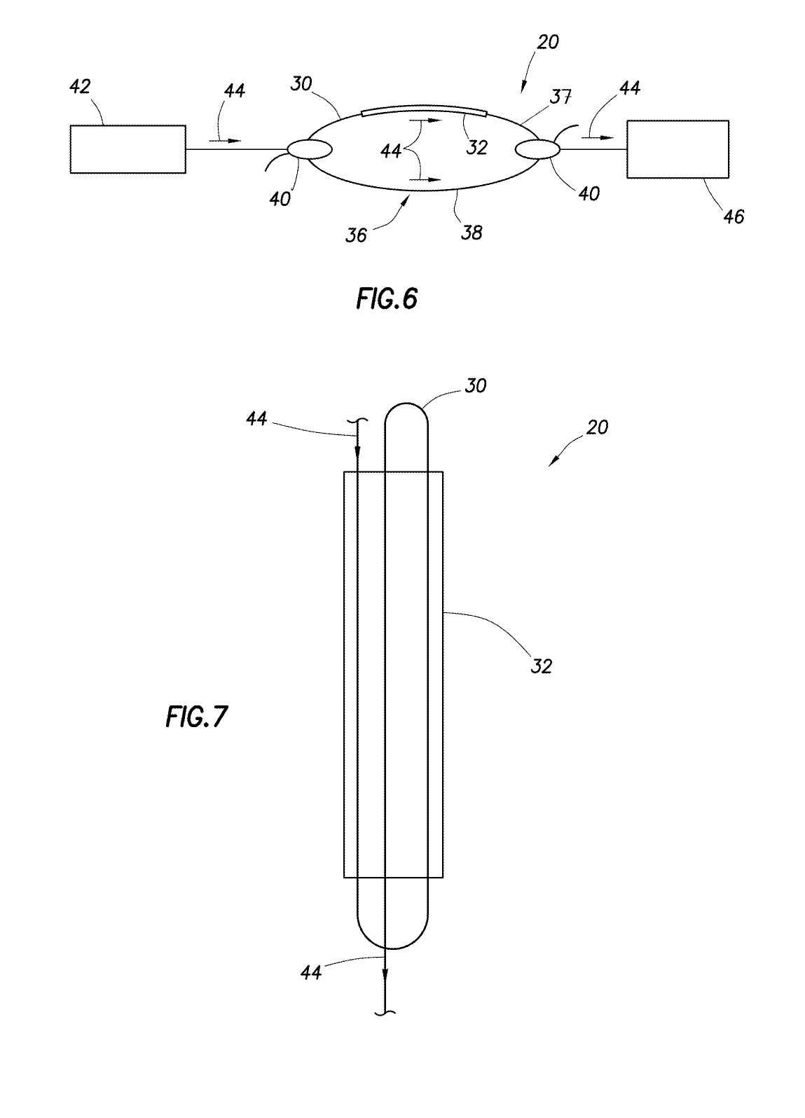

Representatively illustrated in FIG. 6 is a Mach-Zehnder interferometer 36 for measuring strain. The interferometer 36 comprises a sensing arm 37 and a reference arm 38. The material 32 is bonded to, jacketed about, or wrapped about the waveguide 30 which comprises the sensing arm 37 of the interferometer 36. The sensing arm and the reference arm 38 are connected in parallel between two optical couplers 40.

A light source 42 (such as a laser, etc.) transmits light 44 through the sensing arm 37 and the reference arm 38. An optical detector 46 receives the light, which is the interference between the lights 44 from the two arms 37, 38.

If the optical waveguide 30 undergoes strain due to exposure of the material 32 to an electric and/or magnetic field, this changes an optical path length for the light 44 in the sensing arm 37 as compared to the reference arm 38. This change in path length causes an optical phase shift between the light 44 transmitted through the sensing arm 37 and light transmitted through the reference arm 38. The phase change is given by:

Δφ=2πnL/λ*[ε₃−[(P₁₁+P₁₂)ε₁+P₁₂ε₃]n²/2] (5)

where Δφ is a difference in phase, n is the refractive index, L is a length of the waveguide 30 bonded to, jacketed by, or wrapped about the material 32, λ is the wavelength of light 44, P11 and P12 are Pockels coefficients, and ε₁ and ε₃ are strains in transverse and longitudinal directions, respectively.

The phase difference Δφ measured using this method is proportional to the magnetic and/or electric field, which in turn is a measure of resistivity. Of course, other methods may be used for detecting the change in length of the waveguide 30, and for relating this length change to the electromagnetic field strength, in keeping with the scope of this disclosure.

In the FIG. 1 example, the sensors 20 are used for monitoring the flood front 12. The sensors 20 are deployed in the cement 22 external to the casing 24. The sensors 20 comprise a series of equal lengths of waveguide 30 bonded to, jacketed by, or wrapped about the material 32 at equal spacings along the cable 18.

At the sensor 20 locations, an optical signal (such as light 44) transmitted through the waveguide 30 is modulated by a change in shape of the material 32 due to the electromagnetic field 28. The modulated signal from each sensor 20 travels along the cable 18 to a signal interrogation device, where each sensor's signal is extracted and demodulated, enabling a determination of the electromagnetic field strength at each sensor location. In this manner, resistivity of the formation 14 can be mapped along the optical cable 18.

The Bragg gratings 34 can be useful in extracting each sensor's 20 modulated signal. For example, in a wavelength division multiplexing method, the Bragg gratings 34 can be used to reflect selected wavelengths of the light 44 in an intrinsic Fabry-Perot interferometry technique.

An intrinsic Fabry-Perot interferometer comprises two Bragg gratings 34 which are wavelength selective reflectors (light 44 of a given wavelength is reflected selectively). The incident light 44 is partially reflected at a first Bragg grating 34. The remaining light travels through a cavity between the gratings 34, and is again partly reflected at the second grating.

The reflected light 44 from the two Bragg gratings 34 is re-coupled into the same optical fiber and guided to a multichannel phase demodulator (similar to the detector 46 of FIG. 6). There will be a change in phase between the light 44 reflected from the first Bragg grating 34, and light reflected from the second Bragg grating, due to a strain induced in the fiber bonded to material 32 between the gratings.

In this example, each sensor comprises a pair of Bragg gratings 34 designed to reflect a given wavelength, so that the signal from one sensor can be distinguished from others at the interrogator. The change in phase at each sensor 20 indicates a respective resistivity of the formation 14 at each sensor.

However, the scope of this disclosure is not limited to use of any particular multiplexing technique. Other optical multiplexing techniques (such as time division multiplexing, etc.) may be used also, or alternatively.

Referring additionally now to FIG. 7, another example of the sensor 20 is representatively illustrated. In this example, the waveguide 30 is bonded to the material 32 repeatedly, so that a change in shape of the material will result in larger strain in the waveguide.

A greater length of the waveguide 30 bonded to, jacketed by, or wrapped about the material 32 results in a greater total strain induced in the waveguide. This technique enhances a sensitivity of the sensor 20 to the electromagnetic field 28.

It may now be fully appreciated that the above disclosure provides significant advancements to the art of detecting electromagnetic fields in subterranean formations, and thereby measuring resistivities of formations. In examples described above, the sensor 20 is sensitive to magnetic and/or electric components of the electromagnetic field 28, which varies based upon a resistivity of the formation 14, enabling monitoring of the progress of the flood front 12. However, it is not necessary for a flood front to be monitored in keeping with the scope of this disclosure.

A method of measuring an electromagnetic field 28 in a subterranean earth formation 14 is provided to the art by the above description. In one example, the method can comprise: installing at least one electromagnetic sensor 20 in a well, the sensor 20 comprising an optical waveguide 30 and a material 32; the material 32 changing shape in response to exposure to the electromagnetic field 28 (e.g., the field due to flood); and strain being induced in the optical waveguide 30 in response to the material 32 changing shape.

The material 32 can comprise a magnetostrictive material, and/or an electrostrictive material.

The material 32 may be positioned between Bragg gratings 34 formed in the optical waveguide 30. For example, an intrinsic Fabry-Perot interferometric sensor may be used. Such interferometric sensors are conveniently multiplexed, as by using wavelength division multiplexing.

The optical waveguide 30 may comprise a sensing arm 37 of an interferometer 36. A Mach Zehnder or Michelson interferometric sensor may be used.

The material 32 may be bonded directly to the optical waveguide 30.

The method can include permanently installing the sensor 20 in a wellbore 16. The sensor 20 may, for example, be installed in cement 22 between a casing 24 and a wellbore 16.

The sensor 20 may detect the electromagnetic field 28 representing resistivity in the formation 14. The sensor 20 may monitor a proximity of a flood front 12, for example, a distance to a flood front from one or more wellbores 16, a moving or stationary interface between fluid compositions in a formation 14, a proximity of a flood front to particular formation zone(s), etc.).

A well system 10 is also described above. In one example, the system 10 can include an optical electromagnetic sensor 20 installed in a well, and a transmitter 26 which induces an electromagnetic field 28 in an earth formation 14. A strain is induced in an optical waveguide 30 bonded to magnetostrictive or electrostrictive material 32 of the sensor 20 in response to the electromagnetic field 28.

Another method of monitoring an earth formation 14 can comprise: installing an optical electromagnetic sensor 20 in a wellbore 16 which penetrates the formation 14; inducing an electromagnetic field 28 in the formation 14; and a strain induced in an optical waveguide 30 of the sensor 20 in response to the electromagnetic field 28 in the formation.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of measuring an electromagnetic field in a subterranean earth formation, the method comprising:
installing at least one electromagnetic sensor in a well, the sensor comprising an optical waveguide and a material;
the material changing shape in response to exposure to the electromagnetic field induced in the formation; and
strain induced in the optical waveguide in response to the material changing shape.

2. The method of claim 1, wherein the material comprises a magnetostrictive material.

3. The method of claim 1, wherein the material comprises an electrostrictive material.

4. The method of claim 1, wherein the material is positioned between Bragg gratings formed in the optical waveguide.

5. The method of claim 1, wherein the strain is measured using any method including interferometric methods, such as intrinsic Fabry-Perot, Michelson or Mach Zhender interferometry.

6. The method of claim 1, wherein the optical waveguide comprises a sensing arm of an interferometer.

7. The method of claim 1, wherein the material is bonded directly to or coated on the optical waveguide.

8. The method of claim 1, further comprising permanently installing the sensor in a wellbore.

9. The method of claim 1, further comprising installing the sensor in cement between a casing and a wellbore.

10. The method of claim 1, further comprising the sensor detecting the electromagnetic field representing resistivity in the formation.

11. The method of claim 1, further comprising the sensor monitoring a proximity of a flood front.

12. A well system, comprising:
an optical electromagnetic sensor installed in a well; and
wherein a strain is induced in an optical waveguide of the sensor in response to an electromagnetic field induced in an earth formation.

13. The system of claim 12, wherein the sensor further comprises a material which changes shape in response to exposure to the electromagnetic field.

14. The system of claim 13, wherein the strain is induced in the optical waveguide in response to a change in the material shape.

15. The system of claim 13, wherein the material comprises a magnetostrictive material.

16. The system of claim 13, wherein the material comprises an electrostrictive material.

17. The system of claim 13, wherein the material is positioned between Bragg gratings formed in the optical waveguide.

18. The system of claim 13, wherein the material is bonded directly to or coated on the optical waveguide.

19. The system of claim 13, wherein the strain is measured using any method including interferometric methods, such as intrinsic Fabry-Perot, Michelson or Mach Zhender interferometry.

20. The system of claim 12, wherein the optical waveguide comprises a sensing arm of an interferometer.

21. The system of claim 12, wherein the sensor is permanently installed in a wellbore.

22. The system of claim 12, wherein the sensor is positioned in cement between a casing and a wellbore.

23. The system of claim 12, wherein the sensor detects the electromagnetic field representing resistivity in the formation.

24. The system of claim 12, wherein the sensor monitors a proximity of a flood front.

25. A method of monitoring an earth formation, the method comprising:
installing an optical electromagnetic sensor in a wellbore which penetrates the formation; and
a strain being induced in an optical waveguide of the sensor in response to an electromagnetic field induced in the formation.

26. The method of claim 25, wherein the sensor further comprises a material which changes shape in response to exposure to the electromagnetic field.

27. The method of claim 26, wherein the strain is induced in the optical waveguide in response to a change in the material shape.

28. The method of claim 26, wherein the material comprises a magnetostrictive material.

29. The method of claim 26, wherein the material comprises an electrostrictive material.

30. The method of claim 26, wherein the strain is measured using any method including interferometric methods, such as intrinsic Fabry-Perot, Michelson or Mach Zhender interferometry.

31. The method of claim 26, wherein the material is positioned between Bragg gratings formed in the optical waveguide.

32. The method of claim 26, wherein the material is bonded directly to or coated on the optical waveguide.

33. The method of claim 25, wherein the optical waveguide comprises a sensing arm of an interferometer.

34. The method of claim 25, wherein the installing further comprises permanently installing the sensor in a wellbore.

35. The method of claim 25, wherein the installing further comprises positioning the sensor in cement between a casing and a wellbore.

36. The method of claim 25, further comprising the sensor detecting the electromagnetic field representing resistivity in the formation.

37. The method of claim 25, further comprising the sensor monitoring a proximity of a flood front.
